(19) United States
(12) Patent Application Publication
(10) Pub. No.: US 2012/0225339 A1
(43) Pub. Date: Sep. 6, 2012

(54) BATTERY PACK

(75) Inventors: Tomonori Nakaguchi, Hyogo (JP); Tatsutsugu Hashimoto, Osaka (JP)

(73) Assignee: Panasonic Corporation, Osaka (JP)

(21) Appl. No.: 13/508,526

(22) PCT Filed: Feb. 22, 2011
(86) PCT No.: PCT/JP2011/000980

§ 371 Date: May 7, 2012

(30) Foreign Application Priority Data
Mar. 15, 2010 (JP) 2010-057065

(51) Int. Cl. H01M 2/10

(52) U.S. Cl. 429/96

(57) ABSTRACT

A battery pack including a battery, and a case for housing the battery, the case including: a top surface plate; a bottom surface plate; side surface plates defining the space therebetween; first connecting portions connecting the top surface plate and the side surface plates; and second connecting portions connecting the bottom surface plate and the side surface plates, wherein at least one group of the first connecting portions and the second connecting portions has a thick portion or a thin portion. The thick portion or the thin portion may be: provided entirely across the edge-lines formed by the first connecting portions or by the second connecting portions; provided partially along the edge-line formed thereby; or provided intermittently along the edge-line formed thereby.

### TECHNICAL FIELD

The present invention relates to a battery pack comprising a battery and a case for housing the battery, and specifically relates to a battery pack comprising a plurality of electrically-connected secondary batteries and an outer case made of synthetic resin for housing the batteries.

### BACKGROUND ART

In recent years, due to increase in integrated circuits for installment in devices such as laptop computers (hereinafter referred to as laptops) and mobile communication devices for enabling higher functionality, components for installment therein are being reduced in size and weight. Likewise, reductions in size and weight of digital still cameras, as well as reductions in thickness and weight of portable music players are also in progress. This has resulted in stronger demand for reductions in thickness and weight of battery packs for installment in the above devices. A battery pack comprises a battery, and an outer case for housing the battery in a manner such that it is capable of supplying power to the outside.

In devices such as a conventional laptop, a prismatic battery pack having a thickness of 3 mm to 20 mm is used. To reduce battery pack size while also securing sufficient battery capacity, the material constituting the outer case is required to be made thinner. Frequently used as such material is, for example, a plate having a thickness of about 0.5 mm.

On the other hand, high quality is required of battery packs. For example, in instances where a battery pack is to be incorporated into a laptop, highly accurate dimensions are required thereof. There is also a strong demand for improvement in battery safety by securing mechanical strength for drop impact resistance. To meet these demands, it is important that the outer case of a battery pack is prevented from deformation such as warpage, so as to reduce distortions of the battery pack as well as to improve ease of attaching the battery pack to a device.

The outer case typically comprises a top surface plate, a bottom surface plate, and side surface plates defining the space between the top and bottom surface plates. For example, as illustrated in PTL 1, the outer case is constituted of: a first case comprising a top surface plate and a part of side surface plates, and having an opening; and a second case comprising a bottom surface plate and the remainder of the side surface plates, and which closes the opening of the first case. These cases are typically obtained by subjecting a synthetic resin to injection molding. The top surface plate (or the bottom surface plate) and the side surface plates are molded in a manner such that they have equal thickness. Such cases are prone to deformation such as warpage due to the resin shrinking, etc., during molding.

In molding the outer case, a mold having a cavity of a predetermined shape is used. Therefore, in view of preventing deformation such as warpage in the outer case, a proposal has been made to suppress shrinking of the resin by controlling the cooling time of the resin during molding (c.f., PTL 2). Specifically, the cooling time is calculated with use of output signals from a temperature sensor embedded near the cavity, in a manner such that the cooling time can be made long in accordance with rise in the mold temperature.

For balanced shrinking of the molded product, a proposal has also been made to maintain pressure in the cavity at a high level for a predetermined period of time, in the manner of injecting gas into a cavity which is defined by a movable mold and a fixed mold, the gas being injected from the movable mold around when the molten resin starts to harden (c.f., PTL 3).

### CITATION LIST

### Patent Literature(s)

[PTL 1] Japanese Laid-Open Patent Publication No. 2008-135342

[PTL 2] Japanese Laid-Open Patent Publication No. Hei 6-254929

[PTL 3] Japanese Laid-Open Patent Publication No. 2003-245937

### SUMMARY OF INVENTION

### Technical Problem

However, even with controlling the cooling time during molding as proposed in PTL 2, there is difficulty in obtaining control that is highly accurate to the extent of enabling suppression of subtle warps in the outer case.

Also, in instances where the pressure in the cavity is maintained at a high level as proposed in PTL 3, resin thickness becomes a factor for causing the applied pressure to vary in level. Thus, the condition in which the resin shrinks during molding also varies, resulting in difficulty in suppressing warps.

### Solution to Problem

In view of the fact that difficulty still remains in suppressing warpage in the outer case even when molding conditions are controlled as above, the present invention focuses on suppressing warpage therein by improving the structure of the molded product.

That is, the present invention relates to a battery pack comprising a battery and a case for housing the battery, the case comprising: atop surface plate, a bottom surface plate, side surface plates defining the space between the top and bottom surface plates; first connecting portions for connecting the top surface plate and the side surface plates; and second connecting portions for connecting the bottom surface plate and the side surface plates, wherein at least one group of the first connecting portions and the second connecting portions has a thick portion or a thin portion.

In one embodiment of the present invention, the thick portion is formed, by shaping the inner corner of the first connecting portion or of the second connecting portion, as an arc.

In another embodiment of the present invention, the thick portion is formed, by providing a protrusion along the inner corner of the first connecting portion or of the second connecting portion.

In a further embodiment of the present invention, the thick portion is formed, by making the respective thicknesses of the top surface plate and the side surface plate, or the respective thicknesses of the bottom surface plate and the side surface plate, gradually thicker toward the inner corner of the first connecting portion or of the second connecting portion.

In yet another embodiment of the present invention, the thin portion is formed, by providing a recess along the inner corner of the first connecting portion or of the second connecting portion.

In a still further embodiment of the present invention, the thin portion is formed, by making the respective thicknesses of the top surface plate and the side surface plate, or the respective thicknesses of the bottom surface plate and the side surface plate, gradually thinner toward the inner corner of the first connecting portion or of the second connecting portion.

In another embodiment of the present invention, the thick portion or the thin portion is provided entirely across the edge-lines formed by the first connecting portions or by the second connecting portions.

In a further embodiment of the present invention, the thick portion or the thin portion is provided partially along the edge-line formed by the first connecting portions or by the second connecting portions.

In yet another embodiment of the present invention, the thick portion or the thin portion is provided intermittently along the edge-line formed by the first connecting portions or by the second connecting portions.

### Advantageous Effects of Invention

According to the present invention, it is possible to provide a battery pack in which deformation of its case, such as warpage, is suppressed, regardless of controlling or not controlling molding conditions. Thus, there are improved accuracy in the dimensions of the battery pack and improved ease of attaching the battery pack to an electronic device. Also, residual stress in the case can be reduced, and this facilitates securing mechanical strength of the battery pack. Securing mechanical strength for the battery pack shows promise in also improving safety of the battery pack during use of a device.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 is an exploded perspective view illustrating the structure of a battery pack having a thick portion, according to one embodiment of the present invention.

FIG. 2 is a top view of inside a case for the battery pack.

FIG. 3 is a partially cut-away, perspective view of the case for the battery pack.

FIG. 4 is a perspective view illustrating a first modification of a main part of the case for the battery pack.

FIG. 5 is a perspective view illustrating a second modification of the main part of the case for the battery pack.

FIG. 6 is a conceptual illustration of a warp in a case for a battery pack which is a comparative example for the present invention.

FIG. 7 is a conceptual illustration of a warp in the opposite direction in a case for a battery pack which is a comparative example for the present invention.

FIG. 8 is a partially cut-away, perspective view of a case for a battery pack having a thick portion, according to another embodiment of the present invention.

FIG. 9 is a partially cut-away, perspective view of a case for a battery pack having a thick portion, according to a further embodiment of the present invention.

FIG. 10 is a partially cut-away, perspective view of a case for a battery pack having a thin portion, according to yet another embodiment of the present invention.

FIG. 11 is a perspective view illustrating a first modification of a main part of the case for the battery pack.

FIG. 12 is a perspective view illustrating a second modification of the main part of the case for the battery pack.

FIG. 13 is a partially cut-away, perspective view of a case for a battery pack having a thin portion, according to a still further embodiment of the present invention.

FIG. 14 is a partially cut-away, perspective view of a case for a battery pack having a thin portion, according to another embodiment of the present invention.

FIG. 15 is a partially cut-away, perspective view of a case for a battery pack which is a comparative example for the present invention.

### DESCRIPTION OF EMBODIMENTS

The present invention relates to a battery pack comprising a battery, and a case (hereinafter, outer case) for housing the battery in a manner such that it is capable of supplying power to the outside. Herein, the outer case comprises a top surface plate, a bottom surface plate, and side surface plates defining the space between the top and bottom surface plates. There is no particular limitation to the respective shapes of the top surface plate and the bottom surface plate, but they are usually rectangular or close thereto, with two main pairs of parallel sides, the sides where meeting one another forming a right angle. The side surface plates usually define the space between the top and bottom surface plates, in a manner such that the distance therebetween is uniform.

The outer case comprises, for example: a first case comprising the top surface plate and a part of the side surface plates (hereinafter, first side surface portion), and having an opening; and a second case comprising the bottom surface plate and the remainder of the side surface plates (hereinafter, second side surface portion), and which closes the opening of the first case. The edge portion of the first side surface portion which defines the outline of the opening of the first case, is joined with the edge portion of the second side surface portion of the second case. There is no particular limitation to the method used to join the two edge portions, but they are usually joined by welding or with use of an adhesive, since the outer case is made of resin.

In instances where the outer case comprises the first case and the second case as above, the top surface plate and the first side surface portion are usually molded integrally. Herein, the bent-shaped boundary portions, each being between the top surface plate and the first side surface portion, are called first connecting portions. Likewise, the bottom surface plate and the second side surface portion are usually molded integrally. Herein, the bent-shaped boundary portions, each being between the bottom surface plate and the second side surface portion, are called second connecting portions. However, note that there are instances where the top surface plate and the first side surface portion, or where the bottom surface plate and the second side surface portion, are not molded integrally. For example, it is also possible for only the first case to have the side surface plates, and the second case to be constituted only of the bottom surface plate. Also, there are instances where the top surface plate, the side surface plates, and the bottom surface plate are each molded separately, and then joined together by welding or with use of an adhesive. In such instances, the first connecting portions and the second connecting portions are each joint portions created by welding or with use of an adhesive.

In the present invention, at least one group of the first connecting portions and the second connecting portions has a thick portion or a thin portion. The thick portion or the thin portion is preferably formed in both groups of the first connecting portions and the second connecting portions, in terms of enabling improvement in the effect of suppressing deformation of the outer case. However, note that the effect of suppressing deformation of the outer case can be achieved to a certain extent, even if the thick portion or the thin portion is provided only in the first connecting portions or only in the second connecting portions. Note that it is also possible to provide the thick portion in one group of the first connecting portions and the second connecting portions, and the thin portion in the other group thereof.

The thick portion or the thin portion can be provided in a manner such that it overlaps from the top surface plate onto the side surface plates, or from the bottom surface plate onto the side surface plates. However, note that in the boundary portion between the top surface plate or the bottom surface plate and the side surface plate, the thick portion or the thin portion may be provided closer to the side surface plate side, closer to the top surface plate side, or closer to the bottom surface plate side.

Providing the thick portion or the thin portion as above enables improvement in balanced shrinkage of the resin, and suppression of deformation such as warpage. For example, it is considered that the presence of the thick portion or the thin portion reduces the effects caused by shrinkage of the rectangular top surface plate or the rectangular bottom surface plate, and the effects caused by shrinkage of the side surface portions surrounding the four sides thereof. Suppression of deformation of the outer case enables improved accuracy in the dimensions of the battery pack, and also, improved ease of attaching the battery pack to a device.

With suppression of deformation of the outer case, it becomes possible to improve impact resistance of the battery pack, and to seek improvement in its safety. For example, residual stress caused in the portion where the first and second cases join together is reduced, thereby enabling suppression of cleavage in the joined portion at times of drops of the battery pack.

The thick portion or the thin portion is preferably provided on the inner surface side of the outer case. Due to the above, unnecessary recesses and projections will not be formed on the outer surface of the outer case, thereby not adversely affecting the outward appearance of the outer case and the ease of attaching the battery pack to a device.

The thick portion is formed, for example, by shaping the inner corner of the first connecting portion or of the second connecting portion, as an arc. The outer corner of the first connecting portion or of the second connecting portion has an arc shape or a pointed shape with a tip forming a 90 degree angle, an acute angle, or an obtuse angle. In instances where the outer corner has an arc shape, a radius of curvature of the outer corner (Rout) is made smaller (i.e., curvature is made larger) than a radius of curvature of the inner corner (Rin). Specifically, the radius of curvature (Rin) of the arc at the inner corner is, for example, 0.3 mm to 1.2 mm.

In instances where the outer corner has an arc shape, its radius of curvature (Rout) is, for example, 0.2 mm to 0.3 mm. The ratio of Rin/Rout is preferably 2.5 or more, and further preferably 2.5 to 4. This enables easier formation of the thick portion capable of sufficiently suppressing warpage in the case.

Further, it is also possible to form at the inner corner, an arc which corresponds to the radius of a cylindrical battery to be housed in the outer case. Forming the above arc enables reduction of extra space created in the outer case. In such instances, the cylindrical battery can be housed in the outer case, with its cylindrical surface being supported by the inner surface of the thick portion.

Herein, an arc refers to such formed in a vertical section (hereinafter, vertical section of main part) created by cutting the first connecting portion or the second connecting portion, perpendicularly to the top surface plate (or the bottom surface plate) and perpendicularly to the side surface plate. In the vertical section of the main part, the inner surface of the connecting portion creates a simple curve, starting from the top surface plate (or the bottom surface plate), through to the side surface plate. However, note that the above does not apply in instances where the top surface plate (or the bottom surface plate) and the side surface plate each have uniform thickness, and the outer surface of the connecting portion creates an arc of a length corresponding to the radius of the battery to be installed, plus the above thickness.

Although not particularly limited thereto, a thickness T1 of the top surface plate and of the bottom surface plate is typically about 0.5 mm to 1.5 mm, in view of reducing the size and weight of the battery pack. Also, a thickness T2 of the side surface plate is typically 0.3 mm to 1.5 mm.

The thick portion can also be formed, by providing a protrusion along the inner corner of the first connecting portion or of the second connecting portion. In the vertical section of the main part, there is particularly no limitation to the sectional shape of the protrusion at the inner corner. It is, for example: of a pointed projection on the inner surface side with a tip forming a 90 degree angle, an acute angle, or an obtuse angle; or of a projection on the inner surface side, forming an arc. In the vertical section of the main part, the relation among: a distance from the outer corner to the tip of the protrusion (Tcs); the thickness T1 of the top surface plate (or the bottom surface plate); and the thickness T2 of the side surface plate, is, for example, 1.5×T1≦Tcs≦2×T1 and 1.5×T2≦Tcs≦2×T2. With the above ranges, it is easier to form the thick portion that can sufficiently suppress warpage in the case, and it is also possible to sufficiently secure space for housing the battery in the outer case.

The thick portion can also be formed by making the respective thicknesses of the top surface plate and the side surface plate, or the respective thicknesses of the bottom surface plate and the side surface plate, gradually thicker toward the inner corner of the first connecting portion or of the second connecting portion. For example, the respective thicknesses are preferably changed by 30 μm to 160 μm for every 1 mm, within a 3 mm range of a distance L starting from the outer corner. It is considered that this gradual change in the respective thicknesses can improve the effect of stress relaxation which suppresses warpage in the outer case. However, note that, in view of securing sufficient space in the outer case, it is preferable that a thickness of the thickest part of the first connecting portion or of the second connecting portion (tmax: distance from the outer corner to the inner corner) satisfies 1.5×T1≦tmax≦2×T1 and 1.5×T2≦tmax≦2×T2.

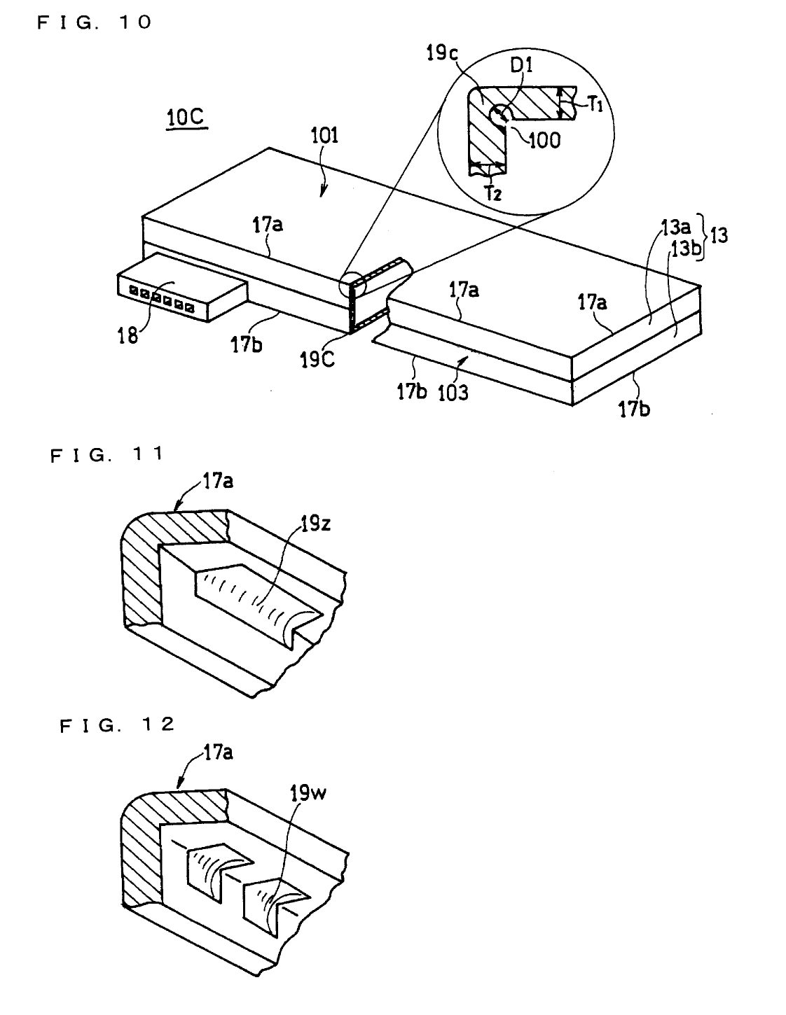

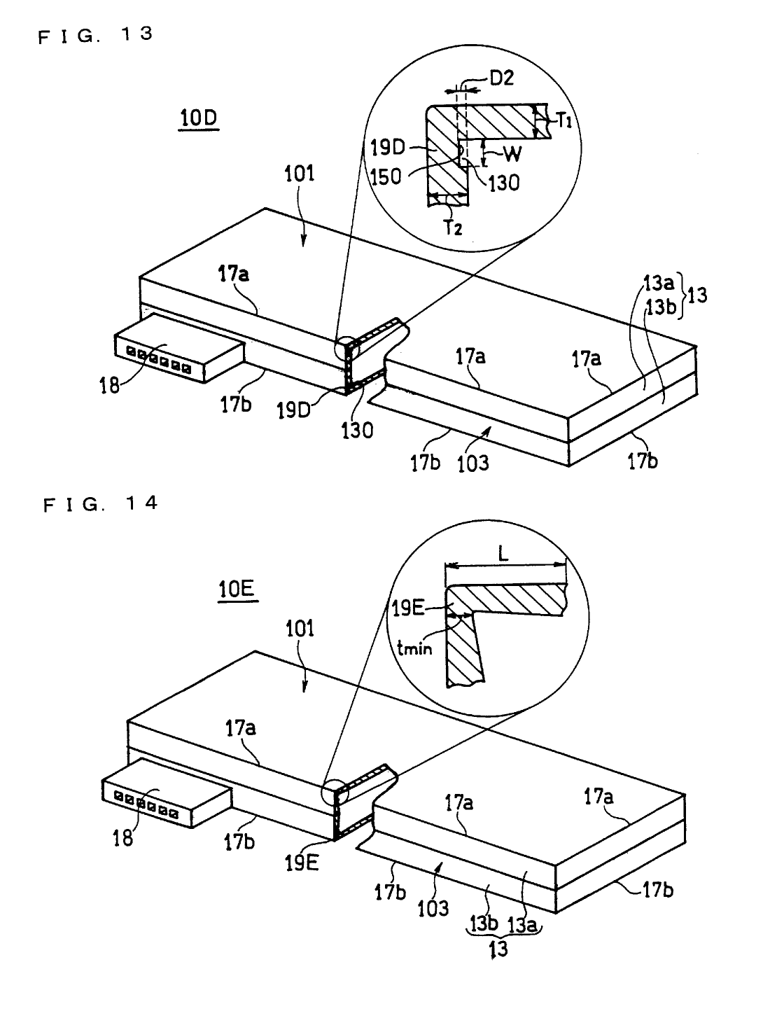

On the other hand, the thin portion is formed, for example, by providing a recess along the inner corner of the first connecting portion or of the second connecting portion. In the vertical section of the main part, the sectional shape of the recess is not particularly limited, but is, for example, a shape of: a projection facing toward the outer surface side, with a tip forming an acute angle or an obtuse angle; a projection facing toward the outer surface side, forming an arc; a recess with a bottom parallel to the top surface plate (or the bottom surface plate); or a recess having a bottom parallel to the side surface plate. The relation among: a maximum depth D of the recess (this applies to Dl in FIGS. 10 and D2 in FIG. 13); the thickness T1 of the top surface plate (or the bottom surface plate); and the thickness T2 of the side surface plate, is, for example, 0.5×T1≦D≦0.8×T1 and 0.5×T2≦D≦0.8×T2. With the above ranges, it is easier to form the thin portion that can sufficiently suppress warpage in the outer case, and it is also possible to sufficiently secure strength of the outer case.

The thin portion can also be formed, by making the respective thicknesses of the top surface plate and the side surface plate, or the respective thicknesses of the bottom surface plate and the side surface plate, gradually thinner toward the inner corner of the first connecting portion or of the second connecting portion. For example, the respective thicknesses are preferably changed by 30 μm to 160 μm for every 1 mm, within a 3 mm range of the distance L starting from the outer corner. It is considered that this gradual change in the respective thicknesses can improve the effect of stress relaxation which suppresses warpage in the outer case. However, note that, in view of securing mechanical strength of the outer case, it is preferable that a thickness of the thinnest part of the first connecting portion or of the second connecting portion (tmin) satisfies 0.5×T1≦tmin≦0.8×T1 and 0.5×T2≦tmin≦0.8×T2.

The thick portion and the thin portion as above can be provided in the first case and the second case, in any arbitrary combination. For example, it is possible: to provide in the first case, the thick portion shaped as an arc, while also providing in the second case, the thick portion shaped as a protrusion; or, to provide in the first case, the thin portion comprising the recess having the bottom parallel to the top surface plate, while also providing in the second case, the thick portion shaped as a protrusion.

The thick portion or the thin portion may be provided entirely across the edge-lines formed by the first connecting portions or by the second connecting portions, or may be provided partially along the edge-line formed thereby. However, note that the partial thick portion or the partial thin portion is preferably provided in corresponding positions on the parallel sides (edge-lines) facing each other. The thick portion or the thin portion is particularly preferably provided intermittently along the edge-line formed by the first connecting portions or by the second connecting portions. At this time, the intervals between the adjacent thick portions or between the adjacent thin portions are preferably made equal on one side (edge-line). It is considered that, by intermittently providing the thick portion or the thin portion as above, there is improvement in the effect of relaxing stress caused in the outer case.

Note that when the total length of the first connecting portions or of the second connecting portions (i.e., respective perimeters of the top surface plate and the bottom surface plate) is designated as L0, a length per the intermittently-provided thick portion or the intermittently-provided thin portion (Ln), for example, preferably satisfies 0.04×L0≦Ln≦0.2×L0. By providing the short thick portion or the short thin portion across a number of areas as above, it is possible, not only to improve the effect of relaxing stress caused in the outer case, but also to improve strength of the outer case. In view of more reliably achieving the above effects, a total length of the areas where the thick portion or the thin portion are provided (LN), is preferably 60% to 70% of the L0.

In the following, a battery pack for use in laptops will be described as a representative example, with reference to the drawings. However, note that the battery pack of the present invention is not limited to use in laptops, and also, that its structure is not limited to the following drawings. The present invention is applicable to battery packs for various uses, such as in: small electronic devices such as digital still cameras, portable music players, and cellular phones; electric tools; electric bicycles; electric vehicles; and hybrid vehicles.

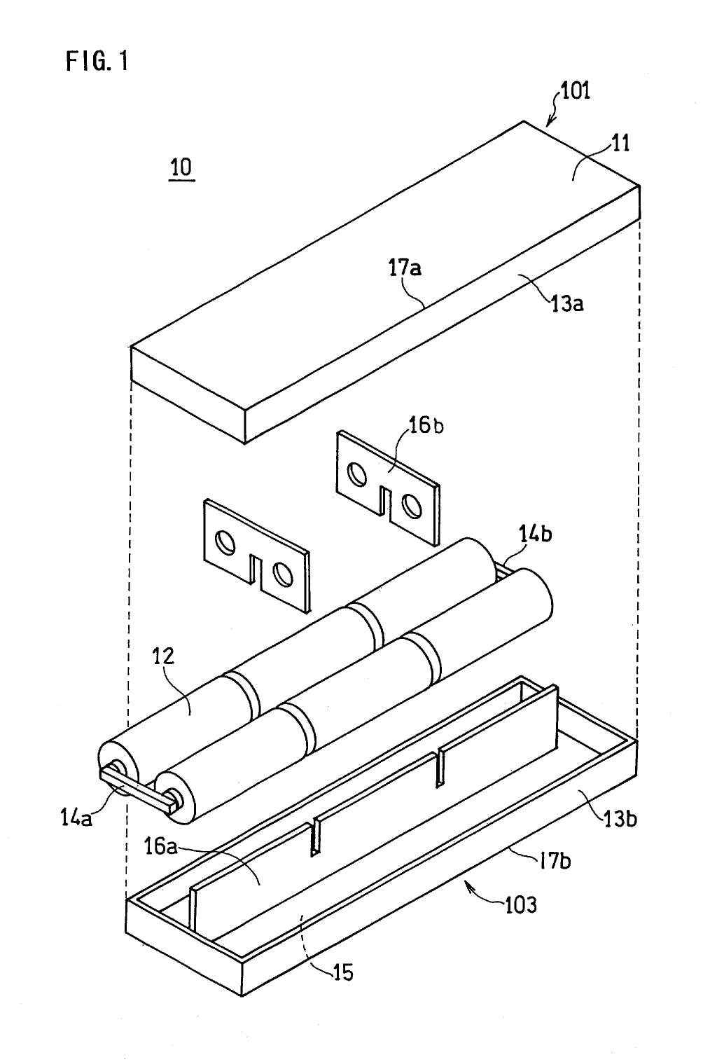

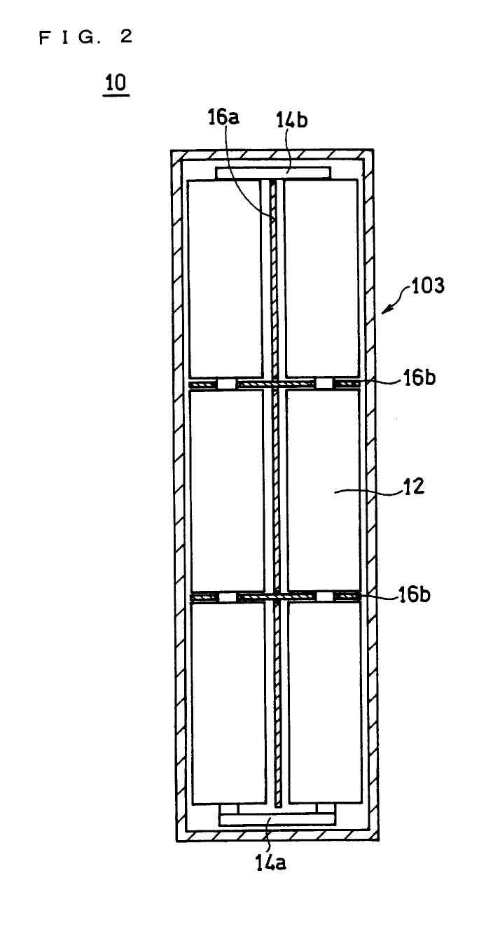

FIGS. 1 and 2 illustrate the structure of a battery pack having a thick portion, according to one embodiment of the present invention. The battery pack 10 comprises: a first case 101, having a rectangular top surface plate 11, and a first side surface portion 13a which extends perpendicularly from the four sides thereof; and a second case 103, having a bottom surface plate 15, and a second side surface portion 13b which extends from the four sides thereof. The edge portion of the first side surface portion 13a defines the outline of the opening of the first case 101, and is matched and joined with the edge portion of the second side surface portion 13b which likewise defines the outline of the opening of the second case 103. The first side surface portion 13a and the second side surface portion 13b are integrated together, thereby constituting side surface plates 13 which define the space between the top surface plate and the bottom surface plate.

In the outer case, a plurality of batteries 12 is housed in a manner such that the batteries are capable of supplying power to the outside. Specifically, a group of three batteries 12 connected in series is designated as one set. Two sets of these battery groups are connected in parallel with use of leads 14a and 14b, and are thus arranged side by side. The battery assembly comprising a total of the six batteries 12 is partitioned with a center partition plate 16a which partitions the two sets of the battery groups, and with auxiliary partition plates 16b which each partitions the serially connected batteries 12. With these partitions, it is possible to suppress movement of the batteries 12 inside the outer case, and to have stably maintained connection among the batteries.

Note that the above manner in which the batteries are housed is merely one example, and that there is no particular limitation to the number of batteries or the way the batteries are connected. Also, the center partition plate and the auxiliary partition plates are not absolutely necessary.

The batteries 12 may be primary batteries or secondary batteries, but secondary batteries are typically used. Examples of secondary batteries include lithium ion batteries, nickel-metal hydride batteries, and nickel-cadmium batteries. Lithium ion batteries are used dominantly in particular, in view of their ability to achieve high capacity and high output.

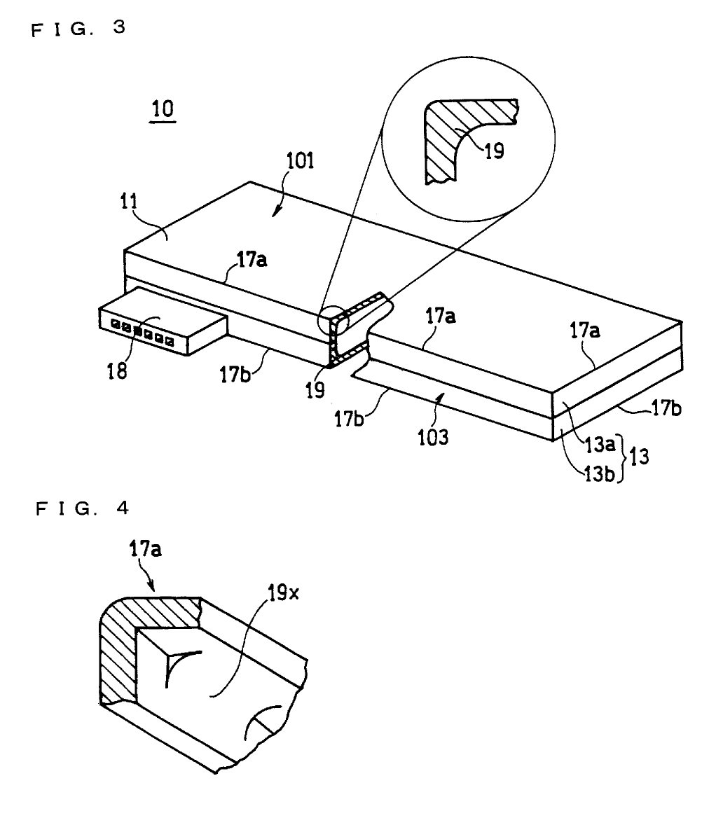

The top surface plate 11 and the first side surface portion 13a are molded integrally, and the bent-shaped boundary portions, each being where these two join together, are first connecting portions 17a. Likewise, the bottom surface plate 15 and the second side surface portion 13b are molded integrally, and the bent-shaped boundary portions, each being where these two join together, are second connecting portions 17b. In FIG. 3, the respective states of the first connecting portion 17a and the second connecting portion 17b are shown, as seen in a partially cut-away portion of the case for the battery pack. However, note that in FIG. 3, the batteries 12 housed in the outer case are not illustrated.

As illustrated in FIG. 3, the first connecting portion 17a and the second connecting portion 17b each have a thick portion 19 which is formed by shaping their respective inner corners as an arc (round shape). Their respective outer corners may be of a pointed shape as illustrated in FIG. 3, but may also be of an arc shape. By providing the thick portion 19, it is possible to obtain the predetermined effect of improving the balance between the shrinkage of the first case 101 and the shrinkage of the second case 103, regardless of controlling or not controlling molding conditions, thereby enabling suppression of deformation such as warpage. Also, the thick portion 19 is formed by shaping the respective inner corners of the first connecting portion 17a and the second connecting portion 17b as an arc, thereby not causing any protruding areas on the outer surface side of the outer case, and not adversely affecting the outward appearance of the battery pack or the ease of attaching the battery pack to a device. Further, there are also improvements in the respective mechanical strengths of the first connecting portion 17a and the second connecting portion 17b.

Note that it is possible to house in the outer case, a circuit board (not illustrated) for protecting the batteries 12 from overcharge and overdischarge. The above circuit board has a plurality of inner terminals, and the inner terminals are connected to leads 14a and 14b, respectively. Also, the circuit board is connected to a connector 18 which is for attaching the battery pack to a device such as a laptop. Via the connector 18, power is supplied from the battery to the laptop (discharge) and the battery is charged with use of an outside power source.

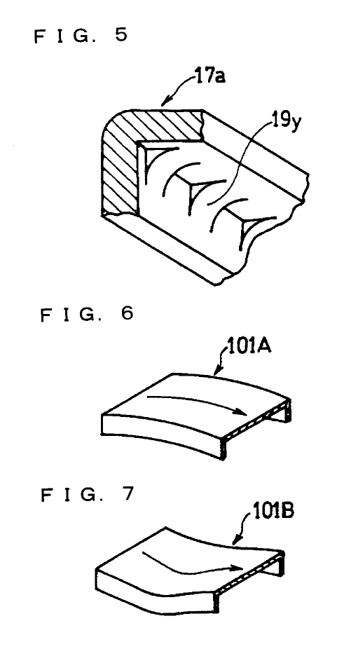

The thick portion may be provided entirely across the edge-lines formed by the first connecting portions 17a and by the second connecting portions 17b, or, as illustrated in FIG. 4, may be a thick portion 19x of a predetermined length (e.g., length: 20 mm to 40 mm), provided partially along the edge-line formed by the first connecting portions and the edge-line formed by the second connecting portions. Also, as illustrated in FIG. 5, a thick portion 19y short in length (e.g., length: 15 mm to 20 mm) may be provided intermittently, at equal intervals for example, on a number of areas along the edge-line formed by the first connecting portions and the edge-line formed by the second connecting portions.

Further, an arc having a radius of curvature corresponding to the radius of the battery to be housed in the outer case (Rin), may be formed at the respective inner corners of the first connecting portion and the second connecting portion. It is also possible to house the battery in the battery pack without any extra space created therein, by designing the above thick portions in accordance with the state of the battery to be housed therein. As a result, the battery is stably supported inside the outer case, while strength of the battery pack is also improved.

In instances where the thick portion or the thin portion is not provided at the first connecting portion and the second connecting portion, the first case and the second case may warp outwardly (i.e., a case 101A) as illustrated in FIG. 6, or may warp inwardly (i.e., a case 101B) as illustrated in FIG. 7. Such warps are considered to be caused due to stress, resulting from resin shrinkage or the like, remaining in the first connecting portion between the top surface plate and the side surface plate or in the second connecting portion between the bottom surface plate and the side surface plate. On the other hand, in instances where the thick portion is provided, stress resulting from shrinkage upon cooling and hardening of molten resin is likely to be generated in a uniform manner, and such warps are thus considered to be reduced. Likewise, in instances where the thin portion is provided, stress resulting from shrinkage upon cooling and hardening of molten resin is likely to be generated in a uniform manner, and such warps are thus considered to be reduced.

A warp or a warp in the opposite direction as above tends to become larger, more at times when molding a case of a shape that is likely to be unevenly balanced in resin shrinkage. For example, an outward warp is likely to develop when the tensile stress due to the shrinkage of the top surface plate or the bottom surface plate becomes greater than the tensile stress due to the shrinkage of the side surface plate. Also, an inward warp is likely to develop when the tensile stress due to the shrinkage of the top surface plate or the bottom surface plate becomes smaller than the tensile stress due to the shrinkage of the side surface plate.

Next, a method for producing the outer case will be described.

The first case 101 and the second case 103 can respectively be obtained, by subjecting a composition mainly composed of a synthetic resin, e.g., a thermoplastic resin, to injection molding, with use of a predetermined mold. The manner in which injection molding is performed is not particularly limited, but in view of improving the effect of suppressing warpage in the outer case, factors during molding such as temperature of the mold and pressure inside the mold may be controlled, as done conventionally.

Examples of the thermoplastic resin include: polyolefins such as polypropylene; polyesters such as polycarbonate, polyethylene terephthalate, and polybutylene terephthalate; polyamides; and liquid crystal polymers. The resin composition can contain various additives such as inorganic fillers and flame retardants.

The mold used for injection molding usually comprises: a concave mold having a hollow part of a predetermined shape; and a convex mold having a protruding part which matches with the hollow part, with a predetermined space therebetween. The space created between the hollow part and the protruding part, is a cavity into which the resin is injected. Sprue, runners, and gates are provided on the mold. The resin in a molten state is injected, from an injector nozzle, into the mold that has been clamped closed. The resin is introduced into the cavity via the sprue, runners, and gates. After the molten resin in the mold cools and hardens, the mold is opened. The above series of operations is usually controlled by a predetermined control device.

The molded case is taken out of the mold that has been opened. Thereafter, the partition plates, the circuit board, the connector, etc. are attached to the first case or the second case; the batteries and the leads are incorporated thereinto; and the respective open edge portions of the first case and the second case are matched and joined together, thereby obtaining a battery pack.

Next, another form of the thick portion will be described.

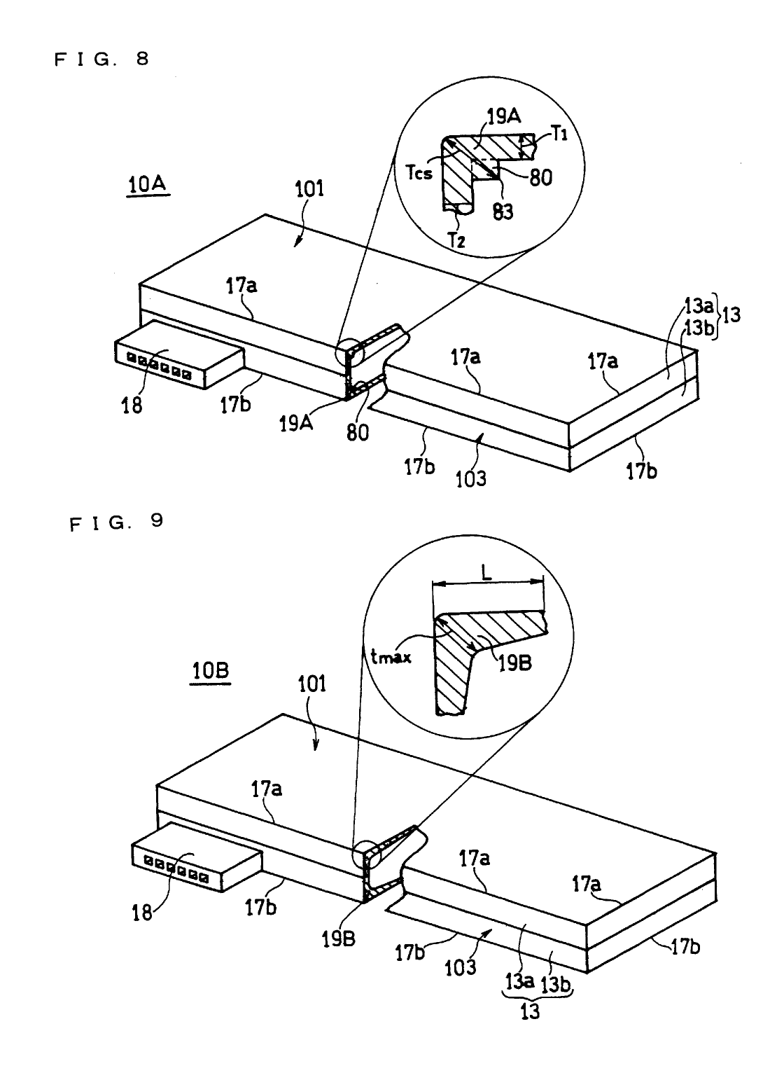

A thick portion 19A of a battery pack 10A in FIG. 8 is formed, by providing a protrusion 80 along the respective inner corners of the first connecting portion 17a and the second connecting portion 17b. In the vertical section of the main part, the sectional shape of the protrusion is of a pointed projection on the inner surface side, with a tip 83 forming an angle of about 90 degrees. By forming the thick portion as above, it is possible to achieve effects such as suppressing warpage and improving mechanical strength of the outer case, as with the thick portion illustrated in FIG. 3. It is also possible to further improve the mechanical strength.

A thick portion 19B of a battery pack 10B in FIG. 9 is formed: by making the respective thicknesses of the top surface plate and the side surface plate, gradually thicker toward the inner corner of the first connecting portion; and by also making the respective thicknesses of the bottom surface plate and the side surface plate, gradually thicker toward the inner corner of the second connecting portion. The respective thicknesses of the top surface plate, the bottom surface plate, and the side surface plates are increased by a fixed increment until near the respective corners of the connecting portions, and the vertical section of the corners is shaped as an arc. Also, near the respective corners of the connecting portions, the respective inner surfaces of the top surface plate (or the bottom surface plate) and the side surface plate are inwardly inclined, whereas the respective outer surfaces thereof are flat. Therefore, the battery pack has a fixed outer thickness. By forming the thick portion as above, it is possible to achieve effects such as suppressing warpage and improving mechanical strength of the outer case, as with the thick portion illustrated in FIG. 3. It is also possible to further improve the effect of suppressing warpage.

Next, a description will be given on the structure of a battery pack having a thin portion, according to another embodiment of the present invention.

A thin portion 19C of a battery pack 10C in FIG. 10 is formed, by providing along the respective inner corners of the first connecting portion 17a and the second connecting portion 17b, a recess 100 having a depth D1, and a shape of a projection forming an arc facing toward the outer surface side. By forming the thin portion as above, it is possible to achieve effects such as suppressing warpage and improving mechanical strength of the outer case, as with the thickness portion illustrated in FIG. 3.

The thin portion may be provided entirely across the edge-lines formed by the first connecting portions 17a and by the second connecting portions 17b, or, as illustrated in FIG. 11, may be a thin portion 19z of a predetermined length (e.g., length: 20 mm to 40 mm), provided partially along the edge-line formed by the first connecting portions 17a and the edge-line formed by the second connecting portions 17b. Also, as illustrated in FIG. 12, a thin portion 19w short in length (e.g., length: 15 mm to 20 mm) may be provided intermittently, at equal intervals for example, on a number of areas along the edge-line formed by the first connecting portions 17a and the edge-line formed by the second connecting portions 17b.

Next, another form of the thin portion will be described.

A thin portion 19D of a battery pack 10D in FIG. 13 is formed, by providing along the respective inner corners of the first connecting portion and the second connecting portion, a recess 130 having a depth D2 and a bottom 150 parallel to the side surface plate. By forming the thin portion as above, it is possible to achieve effects such as suppressing warpage and improving mechanical strength of the outer case, as with the thin portion illustrated in FIG. 10. The relation among: a width W of the bottom 150 of the recess 130; the thickness T1 of the top surface plate (or the bottom surface plate); and the thickness T2 of the side surface plate, is, for example, 0.5×T1≦W≦1×T1 and 0.5×T2≦W≦1×T2. The above also applies to instances where a recess having a bottom parallel to the top surface plate or the bottom surface plate is provided, in place of the recess having the bottom parallel to the side surface plate.

A thin portion 19E of a battery pack 10E in FIG. 14 is formed: by making the respective thicknesses of the top surface plate and the side surface plate, gradually thinner toward the inner corner of the first connecting portion; and by also making the respective thicknesses of the bottom surface plate and the side surface plate, gradually thinner toward the inner corner of the second connecting portion. The respective thicknesses of the top surface plate, the bottom surface plate, and the side surface plates are reduced by a fixed increment until near the respective corners of the connecting portions, and the vertical section of the corners is shaped as an arc having a large curvature. Also, near the respective corners of the connecting portions, the respective inner surfaces of the top surface plate (or the bottom surface plate) and the side surface plate are outwardly inclined, whereas the respective outer surfaces thereof are flat. Therefore, the battery pack has a fixed outer thickness. By forming the thin portion as above, it is possible to achieve effects such as suppressing warpage and improving mechanical strength of the outer case, as with the thin portion illustrated in FIG. 10. It is also possible to further improve the effect of suppressing warpage.

In the following, the present invention will be described with reference to Examples. However, note that the present invention is not limited to these Examples.

### EXAMPLE 1

A battery pack having an outer case was produced, the outer case having external dimensions as in FIGS. 1 to 3, being: 200 mm in length in the longitudinal direction; 40 mm in length in the width direction; and 20 mm in height. Herein, polycarbonate to which a flame retardant was added, served as a thermoplastic resin, and injection molding was performed with a predetermined mold, thereby forming a first case and a second case shaped nearly symmetric to each other. The series of operations for the injection molding was controlled by a predetermined control device. Partition plates, a circuit board, a connector, etc. were attached to the obtained case, and as illustrated in FIG. 1, two sets of battery assemblies, each comprising three batteries connected in series, were connected in parallel and then incorporated into the case. Thereafter, the first case and the second case were matched at their respective open edge portions and joined together with an adhesive.

With respect to the outer case, the respective thicknesses of a top surface plate and a bottom surface plate were 1 mm, and the respective thicknesses of side surface plates were 1 mm. A thick portion was formed by shaping the respective inner corners of first connecting portions and of second connecting portions on the case as an arc, and the respective outer corners thereof on the case as an arc having a small radius of curvature. A radius of curvature of the inner corner (Rin) was 1 mm, and a radius of curvature of the outer corner (Rout) was 0.3 mm. Note that the thick portion was formed entirely across the edge-lines formed by the first connecting portions and by the second connecting portions (i.e., formed on the entire respective perimeters of the top surface plate and the bottom surface plate).

### EXAMPLE 2

A battery pack was produced in the same manner as Example 1, except for forming the thick portion entirely across the edge-lines formed by the first connecting portions or by the second connecting portions, by, as illustrated in FIG. 8, providing a protrusion along the inner corner of the first connecting portion or of the second connecting portion, on the case. The sectional shape of the protrusion was of a pointed projection on the inner surface side, with a tip forming a 90 degree angle. A distance from the outer corner to the protrusion tip (Tcs) was 2.8 mm.

### EXAMPLE 3

A battery pack was produced in the same manner as Example 1, except for forming the thick portion entirely across the edge-lines formed by the first connecting portions or by the second connecting portions, on the case, by, as illustrated in FIG. 9, making the respective thicknesses of the top surface plate and the side surface plate, and the respective thicknesses of the bottom surface plate and the side surface plate, gradually thicker toward the inner corner of the first connecting portion or of the second connecting portion. A thickness of the thickest part of the connecting portion (tmax) was 2.8 mm. However, note that the respective thicknesses were gradually changed starting from 1 mm by a fixed increment, within a 3 mm range of a distance L starting from the outer corner.

### EXAMPLE 4

A battery pack was produced in the same manner as Example 1, except for partially providing along the edge-lines formed by the first connecting portions and by the second connecting portions, that is, at both of the edge portions in the longitudinal direction, the thick portion (length: 20 mm) as illustrated in FIG. 4, shaping an arc on the respective inner corners of the first connecting portion and the second connecting portion.

### EXAMPLE 5

A battery pack was produced in the same manner as Example 1, except for intermittently providing along the edge-lines formed by the first connecting portions and by the second connecting portions, that is, at equal intervals (25 mm intervals) on a number of areas, the thick portion (length: 20 mm) as illustrated in FIG. 5, shaping an arc on the respective inner corners of the first connecting portion and the second connecting portion.

### COMPARATIVE EXAMPLE 1

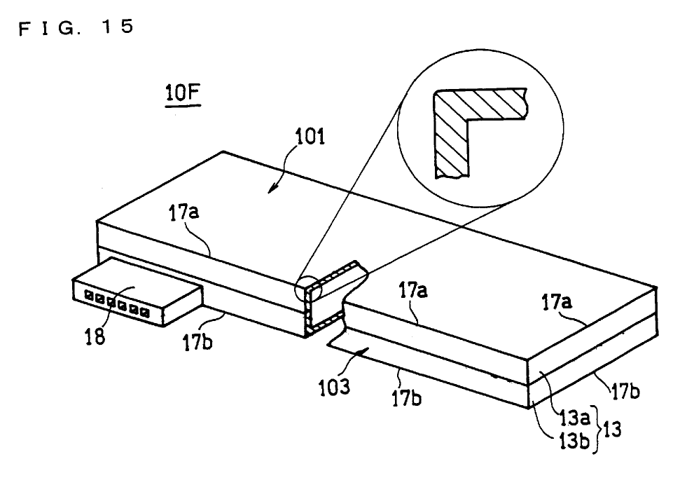

A battery pack 10F was produced in the same manner as Example 1, except for: making the respective thicknesses of the top surface plate and the bottom surface plate of the outer case, 1 mm; and as illustrated in FIG. 15, making the radius of curvature of the inner corner the same as that of the outer corner, thereby not providing the thick portion on any of the first connecting portions and the second connecting portions, on the case.

### COMPARATIVE EXAMPLE 2

A battery pack was produced in the same manner as Comparative Example 1, except for: making the respective thicknesses of the top surface plate and the bottom surface plate of the outer case, 1 mm; and making the thickness of the side surface plate, 0.3 mm.

With respect to the respective outer cases of Examples 1 to 5 and Comparative Examples 1 to 2, the degree of warpage in the top surface plate was measured with use of a dial test indicator. Specifically, the degree of warpage was defined as the height difference between the uppermost point and the lowermost point of the top surface plate.

With respect to the respective battery packs of Examples 1 to 5 and Comparative Examples 1 to 2, the degree of warpage was measured for 30 battery packs and was then averaged out. The results are shown in Table 1. Note that the degree of warpage is shown as a negative value for the warp that was upside-down, of which the height difference was measured in a reversed manner (c.f., FIG. 7).

TABLE 1

| | component | | | |
|---|---|---|---|---|
| | top (bottom) | side surface | | degree of |
| | surface plate | plate thickness | thick | warpage |
| | thickness (mm) | (mm) | portion | (mm) |
| Ex. 1 | 1 | 1 | arc-shaped, | 0.05 |
| | | | all edge-lines | |
| Ex. 2 | 1 | 1 | protrusion- | 0.05 |
| | | | shaped, | |
| | | | all edge-lines | |
| Ex. 3 | 1 | 1 | gradually | 0.05 |
| | | | increased, | |
| | | | all edge-lines | |
| Ex. 4 | 1 | 1 | arc-shaped, | 0.15 |
| | | | partial | |
| Ex. 5 | 1 | 1 | arc-shaped, | 0.1 |
| | | | intermittent | |
| Comp. Ex. 1 | 1 | 1 | none | 1 |
| Comp. Ex. 2 | 1 | 0.3 | none | −0.5 |

As shown in Table 1, it was found that there was lesser degree of warpage in Examples 1 to 5, compared to Comparative Examples 1 to 2. This is considered to be due to providing the thick portion at the connecting portion between the top surface plate (or the bottom surface plate) and the side surface plate, resulting in a thickness difference equally balancing the shrinkage of the case. In contrast, there was a remarkable increase in the degree of warpage in Comparative Examples 1 to 2. Note that in Comparative Example 2, the direction of the warp is opposite of that in Comparative Example 1 (the warp is in the opposite direction). This is considered to be due to being unable to balance out the shrinkage of the top surface plate (or the bottom surface plate) and the shrinkage of the side surface plate, thereby causing the tensile stress of the top surface plate (or the bottom surface plate) to become greater than the tensile stress of the side surface plate.

Examples 4 to 5 show that there is change in the effect of warpage suppression depending on the manner in which the thick portion is provided, and also show that there is remarkably more warpage suppression compared to Comparative Examples 1 to 2, even by only providing the thick portion to a slight extent.

### EXAMPLE 6

A battery pack was produced in the same manner as Example 1, except for: making the respective thicknesses of the top surface plate and the bottom surface plate of the outer case, 1.5 mm; and forming the thin portion entirely across the edge-lines formed by the first connecting portions and the second connecting portions, by, as illustrated in FIG. 10, providing an arc-shaped recess having a depth D1 of 0.5 mm along the inner corner of the first connecting portion or of the second connecting portion.

### EXAMPLE 7

A battery pack was produced in the same manner as Example 6, except for forming the thin portion entirely across the edge-lines formed by the first connecting portions or by the second connecting portions, by, as illustrated in FIG. 13, providing a recess having: a depth D2 of 0.2 mm and a width W of 1 mm; and a bottom parallel to the side surface plate, along the respective inner corners of the connecting portions, on the case.

### EXAMPLE 8

A battery pack was produced in the same manner as Example 6, except for forming the thin portion entirely across the edge-lines formed by the first connecting portions or by the second connecting portions, on the case, by, as illustrated in FIG. 14, making the respective thicknesses of the top surface plate and the side surface plate, and the respective thicknesses of the bottom surface plate and the side surface plate, gradually thinner toward the inner corner of the first connecting portion or of the second connecting portion. A thickness of the thinnest part of the connecting portion (tmin) was 0.3 mm. However, note that the respective thicknesses were gradually changed starting from 1 mm or 1.5 mm by a fixed increment, within a 3 mm range of the distance L starting from the outer corner.

### EXAMPLE 9

A battery pack was produced in the same manner as Example 6, except for, as illustrated in FIG. 11, providing an arch-shaped recess (length: 20 mm) along the edge-lines formed by the first connecting portions and by the second connecting portions, at both of the edge portions in the longitudinal direction.

### EXAMPLE 10

A battery pack was produced in the same manner as Example 6, except for, as illustrated in FIG. 12, intermittently providing an arch-shaped recess (length: 20 mm) at equal intervals (25 mm intervals) on a number of areas along the edge-lines formed by the first connecting portions and by the second connecting portions.

With respect to the respective battery packs of Examples 6 to 10, the degree of warpage was measured for 30 battery packs, and then averaged out. The results are shown on Table 2.

TABLE 2

| | component | | | |
|---|---|---|---|---|
| | top (bottom) | side surface | | degree of |
| | surface plate | plate thickness | thin | warpage |
| | thickness (mm) | (mm) | portion | (mm) |
| Ex. 6 | 1.5 | 1 | recess, | −0.05 |
| | | | all edge-lines | |
| Ex. 7 | 1.5 | 1 | recess, | −0.05 |
| | | | all edge-lines | |
| Ex. 8 | 1.5 | 1 | gradually | −0.05 |
| | | | reduced, | |
| | | | all edge-lines | |
| Ex. 9 | 1.5 | 1 | arc-shaped, | −0.15 |
| | | | partial | |
| Ex. 10 | 1.5 | 1 | arc-shaped, | −0.1 |
| | | | intermittent | |

As shown in Table 2, it was found that there was lesser degree of warpage in Examples 6 to 10, compared to Comparative Examples 1 to 2. This is considered to be due to providing the thin portion at the connecting portion between the top surface plate (or the bottom surface plate) and the side surface plate, resulting in a thickness difference equally balancing the shrinkage in the case.

Examples 9 to 10 show that there is change in the effect of warpage suppression depending on the manner in which the thin portion is provided, and also show that there is remarkably more warpage suppression compared to Comparative Examples 1 to 2, even by only providing the thin portion to a slight extent.

### INDUSTRIAL APPLICABILITY

According to the present invention, it is possible to provide a battery pack in which deformation of its case, such as warpage, is suppressed, regardless of controlling or not controlling molding conditions. Thus, the present invention is useful as a battery pack to be attached to devices requiring high quality, such as laptops.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### LIST OF REFERENCE NUMERALS

10 battery pack

11 top surface plate

12 battery

13 side surface plate

13a first side surface portion

13b second side surface portion

15 bottom surface plate

17a first connecting portion

17b second connecting portion

18 connector

19, 19A, 19B thick portion

19C, 19D, 19E thin portion

101 first case

103 second case

1. A battery pack comprising a battery and a case for housing the battery, the case including: a top surface plate; a bottom surface plate; side surface plates defining the space therebetween; first connecting portions connecting the top surface plate and the side surface plates; and second connecting portions connecting the bottom surface plate and the side surface plates,
wherein at least one group of the first connecting portions and the second connecting portions has a thick portion or a thin portion.

2. The battery pack in accordance with claim 1, wherein the thick portion is formed by shaping the inner corner of the first connecting portion or of the second connecting portion as an arc.

3. The battery pack in accordance with claim 1, wherein the thick portion is formed by providing a protrusion along the inner corner of the first connecting portion or of the second connecting portion.

4. The battery pack in accordance with claim 1, wherein the thick portion is formed by making the respective thicknesses of the top surface plate and the side surface plate, or the respective thicknesses of the bottom surface plate and the side surface plate, gradually thicker toward the inner corner of the first connecting portion or of the second connecting portion.

5. The battery pack in accordance with claim 1, wherein the thin portion is formed by providing a recess along the inner corner of the first connecting portion or of the second connecting portion.

6. The battery pack in accordance with claim 1, wherein the thin portion is formed by making the respective thicknesses of the top surface plate and the side surface plate, or the respective thicknesses of the bottom surface plate and the side surface plate, gradually thinner toward the inner corner of the first connecting portion or of the second connecting portion.

7. The battery pack in accordance with claim 1, wherein the thick portion or the thin portion is provided entirely across the edge-lines formed by the first connecting portions or by the second connecting portions.

8. The battery pack in accordance with claim 1, wherein the thick portion or the thin portion is provided partially along the edge-line formed by the first connecting portions or by the second connecting portions.

9. The battery pack in accordance with claim 1, wherein the thick portion or the thin portion is provided intermittently along the edge-line formed by the first connecting portions or by the second connecting portions.
